(19) United States
(12) Patent Application Publication
(10) Pub. No.: US 2013/0321967 A1
(43) Pub. Date: Dec. 5, 2013

(54) FAULT DETECTION CIRCUIT, ELECTRONIC EQUIPMENT AND FAULT DETECTION METHOD

(71) Applicant: FUJITSU LIMITED, Kawasaki-shi (JP)

(72) Inventors: Kazuki MUNEYASU, Kawasaki (JP); Susumu EDA, Yokohama (JP)

(73) Assignee: FUJITSU LIMITED, Kawasaki-shi (JP)

(21) Appl. No.: 13/771,206

(22) Filed: Feb. 20, 2013

(30) Foreign Application Priority Data
May 29, 2012 (JP) 2012-122407

(51) Int. Cl. H02H 3/00

(52) U.S. Cl. CPC H02H 3/00
USPC 361/88

(57) ABSTRACT

A fault detection circuit includes: a switching element, disposed between a first node and a second node, configured to perform a switching operation in accordance with a control signal; and a detection circuit configured to detect a temporal voltage change at the second node according to the switching operation of the switching element.

### CROSS-REFERENCE TO RELATED APPLICATION

This application is based upon and claims the benefit of priority from the prior Japanese Patent Application No. 2012-122407 filed on May 29, 2012, the entire contents of which are incorporated herein by reference.

### FIELD

The embodiments discussed herein are related to a fault detection circuit, an electronic equipment, and a fault detection method.

### BACKGROUND

Each of functional blocks in electronic equipment has a power supply voltage value, a supply current amount, a degree of voltage precision, or the like which is different from that in another functional block. In a system in which power is generated at one site under centralized control and in which the power is supplied to blocks via long power lines, the intended power supply voltage value or the like of a functional block is not achieved. A power supply circuit disposed close to a corresponding one of the blocks is supplied with input power, and generates power that is adequate for the load therefor. A power supply circuit disposed close to a load is called a point of load (POL).

The related technology is disclosed in Japanese Laid-open Patent Publications No. 2009-100541 and No. 2000-339069.

### SUMMARY

According to one aspect of the embodiments, a fault detection circuit includes: a switching element, disposed between a first node and a second node, configured to perform a switching operation in accordance with a control signal; and a detection circuit configured to detect a temporal voltage change at the second node according to the switching operation of the switching element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary electronic equipment;

FIG. 2 illustrates an exemplary master IC and an exemplary slave IC;

FIG. 3 illustrates an exemplary signal waveform in the electronic equipment;

FIG. 4 illustrates an exemplary malfunction detection circuit;

FIG. 5 illustrates an exemplary operation of a malfunction detection circuit;

FIG. 6 illustrates an exemplary operation of a malfunction detection circuit;

FIG. 7 illustrates an exemplary malfunction detection circuit;

FIG. 8 illustrates an exemplary operation of a malfunction detection circuit; and

FIG. 9 illustrates an exemplary operation of a malfunction detection circuit.

### DESCRIPTION OF EMBODIMENTS

To achieve a load whose response is rapid and whose size is small, a non-isolated DC-DC converter having no isolation transformers may be used as a POL power supply circuit. In the case where a non-isolated DC-DC converter is used, when a short-circuit fault occurs, a large current may be applied to a load from a large-capacity input power source, therefore the load may be damaged. Smoking or ignition may occur in power feed lines (substrate pattern).

To address a short-circuit fault, a load or a power feed line may be protected by inserting a fuse in a power feed line extending from an input power source to a POL. It takes several to several hundreds of milliseconds for a fuse to be blown after a short-circuit fault occurs. Accordingly, a load or a power feed line may fail to be protected with reliability.

When an anomaly is detected in the output voltage of a POL, an alarm signal is transmitted from a slave IC corresponding to the POL to the master IC. Further, an alarm is transmitted from the master IC to the host apparatus which interrupts the input power. However, it takes several tens to several hundreds of milliseconds to stop the input power source after an anomaly is detected. Accordingly, a short circuit current to a load may fail to be immediately stopped.

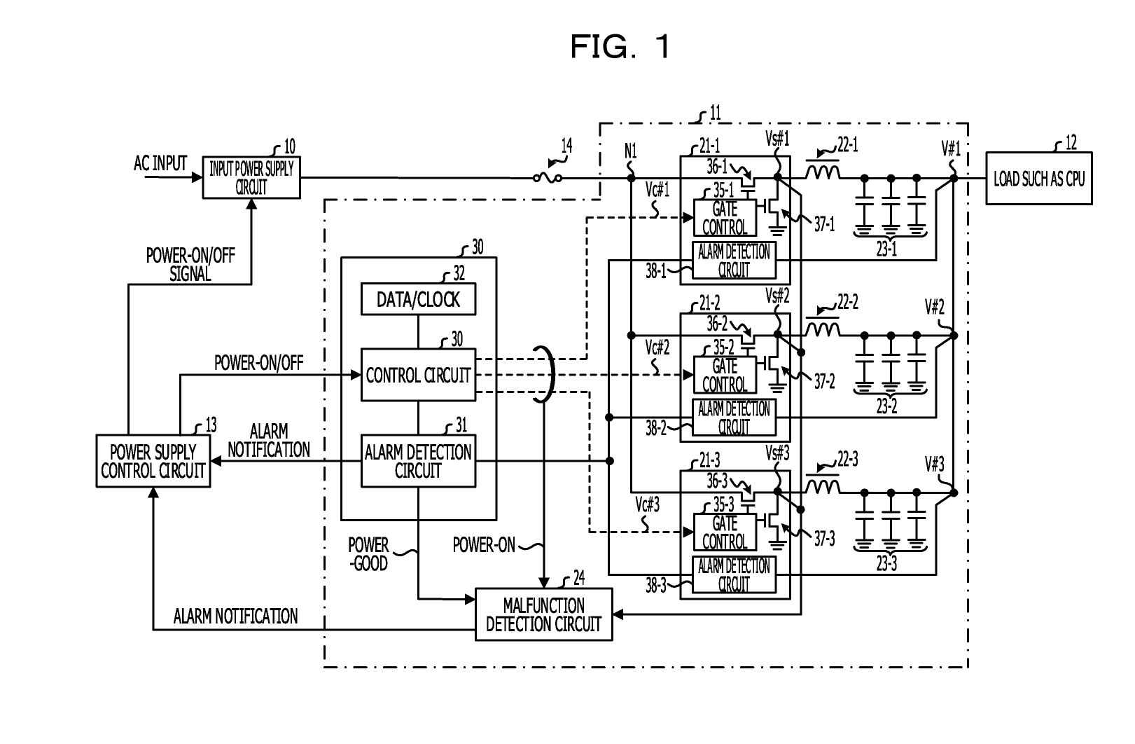

FIG. 1 illustrates an exemplary electronic equipment. The electronic equipment illustrated in FIG. 1 may include a fault detection circuit. The electronic equipment illustrated in FIG. 1 includes an input power supply circuit 10, a Point-of-Load (POL) power supply circuit 11, a load circuit 12, a power supply control circuit 13, and a fuse 14. The input power supply circuit 10 may be, for example, an AC-DC converter. The input power supply circuit 10 converts AC power such as a commercial power supply supplied from the outside, into DC power, and supplies the DC power to the POL power supply circuit 11. The fuse 14 heats up and melts to blow when a short-circuit fault or the like occurs in the POL power supply circuit 11 and a large current flows.

The POL power supply circuit 11 is disposed near the load circuit 12 such as a CPU, and generates power to be supplied to the load circuit 12 based on the DC power from the input power supply circuit 10. The POL power supply circuit 11 includes a master IC 20, slave ICs 21-1 to 21-3, inductors 22-1 to 22-3, capacitors 23-1 to 23-3, and a malfunction detection circuit 24. The master IC 20 includes a control circuit 30, an alarm detection circuit 31, and a data-and-clock unit 32. The slave ICs 21-1 to 21-3 include gate control circuits 35-1 to 35-3, high-side FETs 36-1 to 36-3, low-side FETs 37-1 to 37-3, and alarm detection circuits 38-1 to 38-3, respectively. In FIG. 1, the boundary between functional blocks, each of which is indicated by a box, may be a functional boundary, or may correspond to, for example, separation in terms of a physical position, separation in terms of an electrical signal, or separation in terms of control logic. Each of the functional blocks may be one hardware module separated from another block physically, or may be one function in a hardware module obtained by physically integrating the functional block with other blocks.

The slave ICs 21-1 to 21-3 generate respective output voltages Vs#1 to Vs#3 in accordance with the DC power voltage supplied from the input power supply circuit 10, based on switching operations according to respective control signals Vc#1 to Vc#3 supplied from the control circuit 30 of the master IC 20. The inductors 22-1 to 22-3 and the capacitors 23-1 to 23-3 may be filter circuits which filter the respective output voltages Vs#1 to Vs#3. The waveforms of the output voltages Vs#1 to Vs#3 are smoothed through filtering. For example, smoothed output voltages V#1 to V#3 are combined into one voltage to be supplied to the load circuit 12. The number of slave ICs may be three or may be any. In the case where the number of slave ICs is N, where N is a natural number, output voltages Vs#1 to Vs#N, the number of which is N, and output voltages V#1 to V#N, the number of which is N, are generated.

The alarm detection circuits 38-1 to 38-3 monitor the output voltages V#1 to V#3, respectively, and may also monitor, for example, current or temperature. When, for example, an overvoltage, an overcurrent, or a temperature anomaly is detected, an alarm signal is transmitted to the alarm detection circuit 31 of the master IC 20. The alarm detection circuit 31 supplies an alarm signal to the power supply control circuit 13 in response to the alarm signals from the alarm detection circuits 38-1 to 38-3. The power supply control circuit 13 transmits a power-off signal POWER-OFF to the input power supply circuit 10 in response to the alarm signal. The input power supply circuit 10 interrupts the output DC power in response to the power-off signal POWER-OFF. The alarm detection circuit 31 asserts the power-good signal POWER-GOOD transmitted to the malfunction detection circuit 24 while an alarm signal is not being generated.

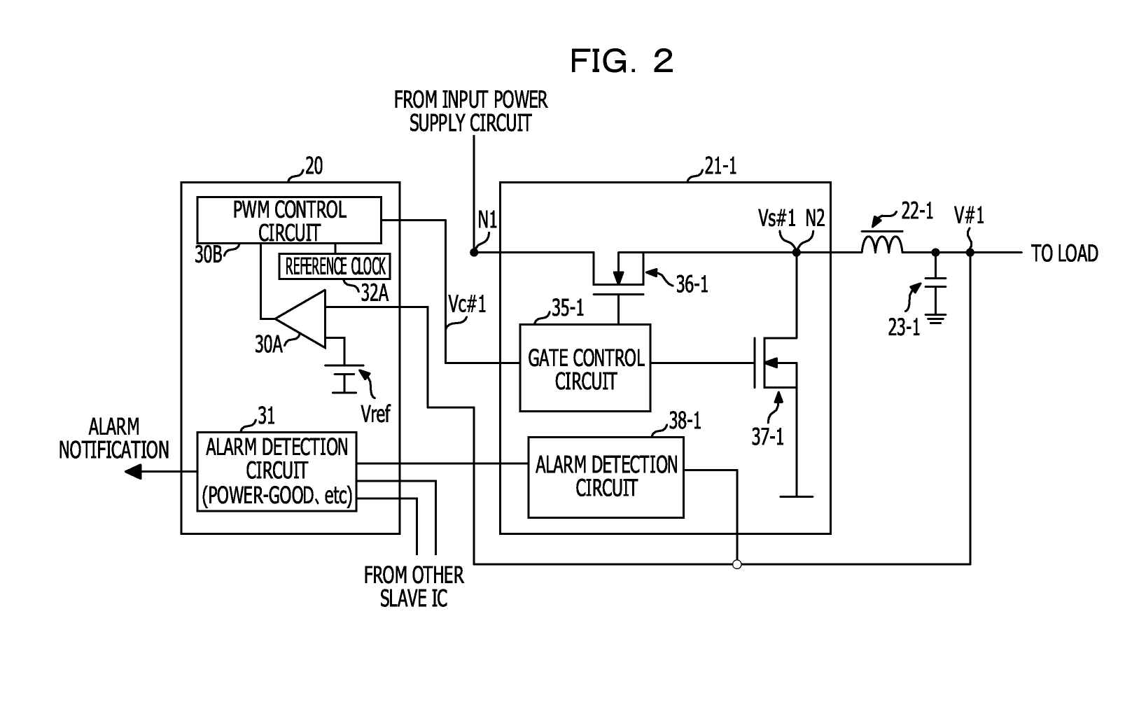

FIG. 2 illustrates an exemplary master IC and an exemplary slave IC. FIG. 2 illustrates the configuration of the slave IC 21-1. The configurations of the slave ICs 21-2 and 21-3 may be substantially the same as or similar to that of the slave IC 21-1. The master IC 20 includes a differential amplifier 30A, a pulse-width modulation (PWM) control circuit 30B, the alarm detection circuit 31, and a reference clock circuit 32A. The differential amplifier 30A and the PWM control circuit 30B may correspond to a part of the control circuit 30. The reference clock circuit 32A may correspond to a part of the data-and-clock unit 32.

The slave IC 21-1 includes the gate control circuit 35-1, the high-side FET (NMOS transistor) 36-1, the low-side FET (NMOS transistor) 37-1, and the alarm detection circuit 38-1. The gate control circuit 35-1 generates a signal to be applied to the gate of the high-side FET 36-1 and a signal to be applied to the gate of the low-side FET 37-1, in accordance with the control signal Vc#1 which alternates between first and second voltages. The signal to be applied to the gate of the high-side FET 36-1 may have a waveform obtained by inverting the waveform of the control signal Vc#1. The signal to be applied to the gate of the low-side FET 37-1 may have a waveform which is substantially the same as that of the control signal Vc#1. The high-side FET 36-1 may be a switching element which performs a switching operation of switching a conducting state and a non-conducting state between a first node N1 and a second node N2 between, in accordance with the control signal Vc#1 which alternates between the first and second voltages. The low-side FET 37-1 may be a switching element which performs a switching operation of switching a conducting state and a non-conducting state between the second node N2 and the ground, in accordance with the control signal Vc#1 which alternates between the first and second voltages. The output voltage Vs#1 is generated at the second node N2 based on the switching operations.

The output voltage Vs#1 is smoothed by the inductor 22-1 and the capacitor 23-1, thereby generating the output voltage V#1. The output voltage V#1 is fed back to the master IC 20, and is applied to the differential amplifier 30A. The differential amplifier 30A amplifies the voltage difference between the output voltage V#1 and a reference voltage Vref, and supplies the resulting voltage to the PWM control circuit 30B. The PWM control circuit 30B generates the control signal Vc#1 which has been subjected to pulse width modulation. For example, the PWM control circuit 30B generates a triangular voltage based on a reference clock supplied from the reference clock circuit 32A, and compares the triangular voltage with the output voltage from the differential amplifier 30A. The control signal Vc#1 which has been subjected to pulse width modulation is generated based on the comparison result. For example, when the output voltage V#1 is lower than a desired voltage, the high period of the control signal Vc#1 is set so as to be relatively shorter than the low period, and feedback control is performed so that the output voltage V#1 increases. For example, when the output voltage V#1 is higher than the desired voltage, the high period of the control signal Vc#1 is set so as to be relatively longer than the low period, and feedback control is performed so that the output voltage V#1 decreases.

The malfunction detection circuit 24 illustrated in FIG. 1 detects presence or absence of a temporal voltage change in the output voltage Vs#1 at a node based on the switching operations of the switching elements (the high-side FET 36-1 and the low-side FET 37-1), e.g., the second node N2 illustrated in FIG. 2. Similarly, the malfunction detection circuit 24 detects presence or absence of a temporal voltage change in the output voltages Vs#2 and Vs#3 based on the switching operations of the high-side FETs 36-2 and 36-3 and the low-side FETs 37-2 and 37-3. When the malfunction detection circuit 24 detects absence of a temporal voltage change, the power supply control circuit 13 stops supply of power supply voltage to the first node N1. For example, when the malfunction detection circuit 24 detects absence of a temporal voltage change in either of the voltages Vs#1 to Vs#3, the malfunction detection circuit 24 supplies an alarm signal to the power supply control circuit 13. The power supply control circuit 13 transmits the power-off signal POWER-OFF to the input power supply circuit 10 in response to the alarm signal. The input power supply circuit 10 stops supply of output DC power to the node N1 in response to the power-off signal POWER-OFF.

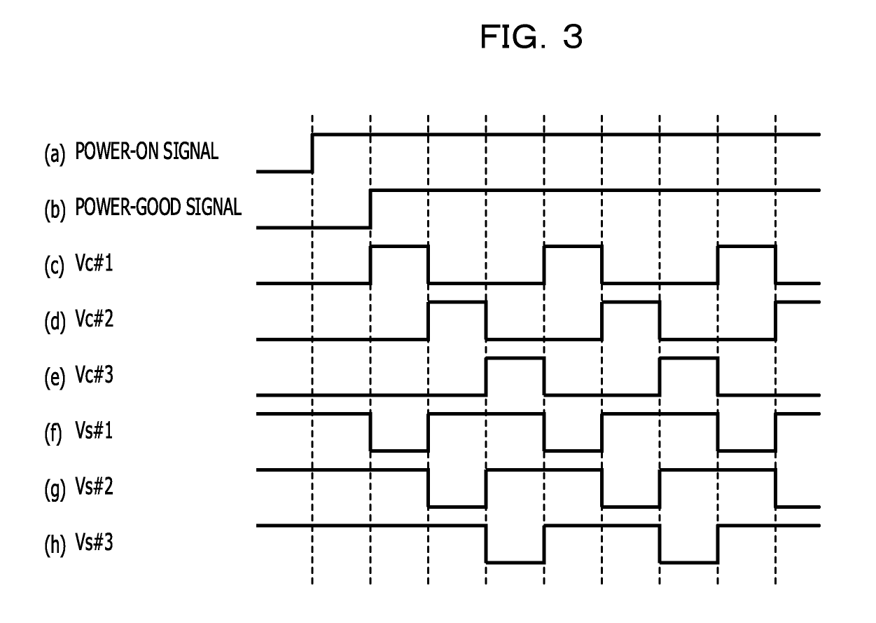

FIG. 3 illustrates an exemplary signal waveform in an electronic equipment. The signal waveforms illustrated in FIG. 3 may be those generated when the electronic equipment illustrated in FIG. 1 normally operates. The signal waveform (a) indicates the power-on signal POWER-ON which indicates a power-on state, e.g., a state in which the power supply is ON, and which is supplied from the control circuit 30 to the malfunction detection circuit 24. The signal waveform (b) indicates the power-good signal POWER-GOOD supplied from the alarm detection circuit 31 to the malfunction detection circuit 24 when the power is on and the operation is normally performed. In a power-on state, the control circuit 30 starts supply of the control signals Vc#1 to Vc#3. As illustrated in the signal waveforms (c) to (e), the control signals Vc#1 to Vc#3 have phases that are shifted from each other. The output voltages Vs#1 to Vs#3 having the signal waveforms (f) to (h) are generated based on the switching operations performed by the transistors in the slave ICs 21-1 to 21-3 in accordance with the control signals Vc#1 to Vc#3.

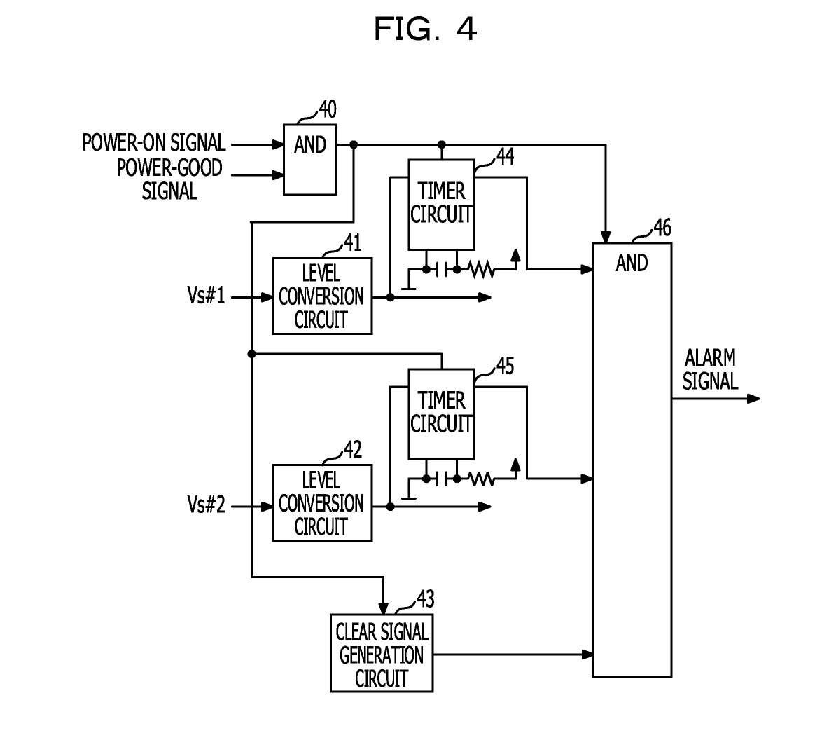

FIG. 4 illustrates an exemplary malfunction detection circuit. For the convenience of explanation, FIG. 4 illustrates a malfunction detection circuit 24 used when two slave ICs are used, e.g., when there are two output voltages. The number of the slave ICs may be any. The malfunction detection circuit 24 illustrated in FIG. 4 includes an AND circuit 40, level conversion circuits 41 and 42, a clear signal generation circuit 43, timer circuits 44 and 45, and an AND circuit 46.

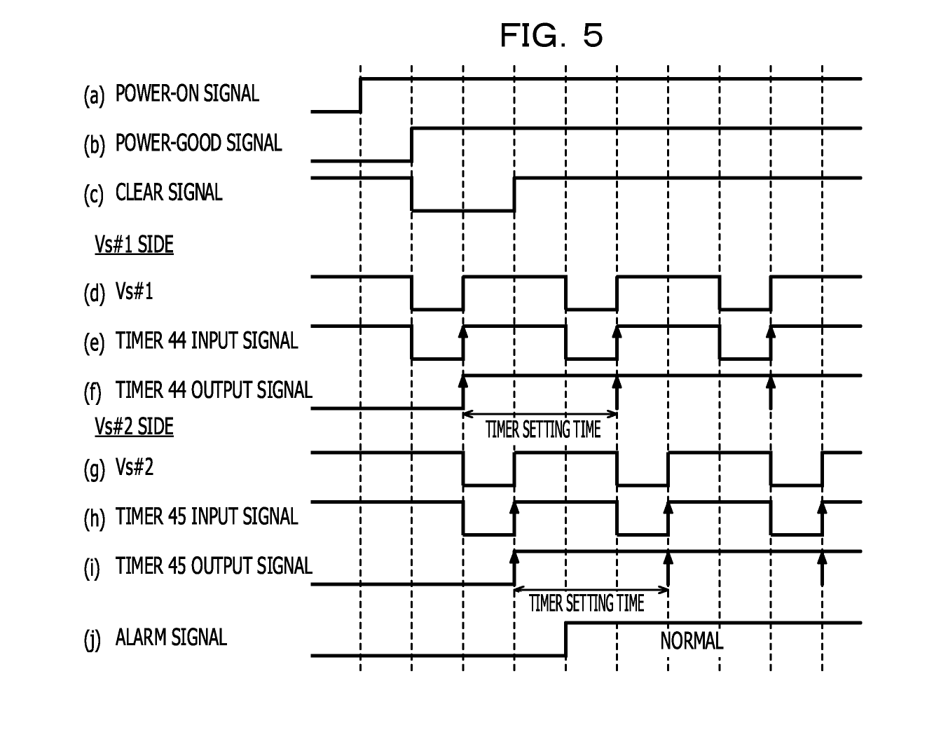

FIG. 5 illustrates an exemplary operation of a malfunction detection circuit. FIG. 5 illustrates signal waveforms of the malfunction detection circuit 24 illustrated in FIG. 4 in a normal operation.

The AND circuit 40 performs an AND operation on the power-on signal POWER-ON (a) and the power-good signal POWER-GOOD (b), and outputs the result of the AND operation. When the output of the AND circuit 40 is set to a HIGH level, the timer circuits 44 and 45 may perform time keeping operations. The output of the AND circuit 40 is supplied to the clear signal generation circuit 43. When the output of the AND circuit 40 is set to the high level, the clear signal generation circuit 43 which outputs a clear signal sets the clear signal to a LOW level for a predetermined time period. After the predetermined time period has elapsed, the clear signal generation circuit 43 sets the clear signal to the high level.

The level conversion circuit 41 receives, for example, the output voltage Vs#1 (d) of the slave IC 21-1 illustrated in FIG. 1, as an input, and generates a signal (e) having an adequate voltage by a level conversion as an input to the timer circuit 44. The timer circuit 44 receives the signal (e) which has been subjected to the level conversion, as an input signal, and sets its output to a high level in response to a rising edge of the input signal. The timer circuit 44 performs a time keeping operation in accordance with the resistance value and the capacitance value of a resistance element and a capacitive element which are external elements, and maintains the output the HIGH level during a predetermined time period from a rising edge of the input signal. After the predetermined time period has elapsed, the timer circuit 44 sets the output back to a low level. When a new rising edge occurs in the input signal while the output is at the high level, the timer circuit 44 starts a new time keeping operation and maintains the output the HIGH level during the predetermined time period from the new rising edge occurs. The predetermined time period, e.g., the timer setting time, may be a time period which is substantially equal to the interval between adjacent rising edges in the timer input signal as illustrated in the signal waveform (f) corresponding to the output of the timer circuit 44. When the output of the timer circuit 44 becomes the low level, a malfunction is detected. Therefore, the predetermined time period may be longer than the interval between adjacent rising edges in the timer input signal to reduce erroneous malfunction detections based on an error.

The level conversion circuit 42 receives, for example, the output voltage Vs#2 (g) of the slave IC 21-2 illustrated in FIG. 1, as an input, and generates a signal (h) having an adequate voltage by a level conversion as an input to the timer circuit 45. The timer circuit 45 receives the signal (h) which has been subjected to the level conversion as an input signal, and sets its output to the high level in response to a rising edge of the input signal. The timer circuit 45 performs a time keeping operation in accordance with the resistance value and the capacitance value of a resistance element and a capacitive element which are external elements, and maintains the output the high level during a predetermined time period from a rising edge of the input signal. After the predetermined time period has elapsed, the timer circuit 45 sets the output back to the low level. When a new rising edge occurs in the input signal while the output is at the high level, the timer circuit 45 starts a new time keeping operation and maintains the output the high level during the predetermined time period from the new rising edge occurs. The predetermined time period, e.g., the timer setting time, may be a time period which is substantially equal to the interval between adjacent rising edges in the timer input signal as illustrated in the signal waveform (i) corresponding to the output of the timer circuit 45. When the output of the timer circuit 45 becomes the low level, a malfunction is detected. Therefore, the predetermined time period may be longer than the interval between adjacent rising edges in the timer input signal to reduce erroneous malfunction detections based on an error.

The AND circuit 46 performs an AND operation on the output signal of the timer circuit 44, the output signal of the timer circuit 45, and the output signal of the clear signal generation circuit 43, and outputs the result of the AND operation. The output of the AND circuit 46 (j) may be an alarm signal which is output from the malfunction detection circuit 24. The alarm signal at the low level indicates an assertion state, e.g., a malfunction detection state. The alarm signal that at the high level indicates a negation state, e.g., a malfunction non-detection state. When the voltages Vs#1 and Vs#2 have a temporal voltage change according to the switching operations, the outputs of the timer circuits 44 and 45 may be set to the HIGH level. At that time, the alarm signal which is the output of the AND circuit 46 becomes the high level, and the negation state, e.g., the malfunction non-detection state, holds.

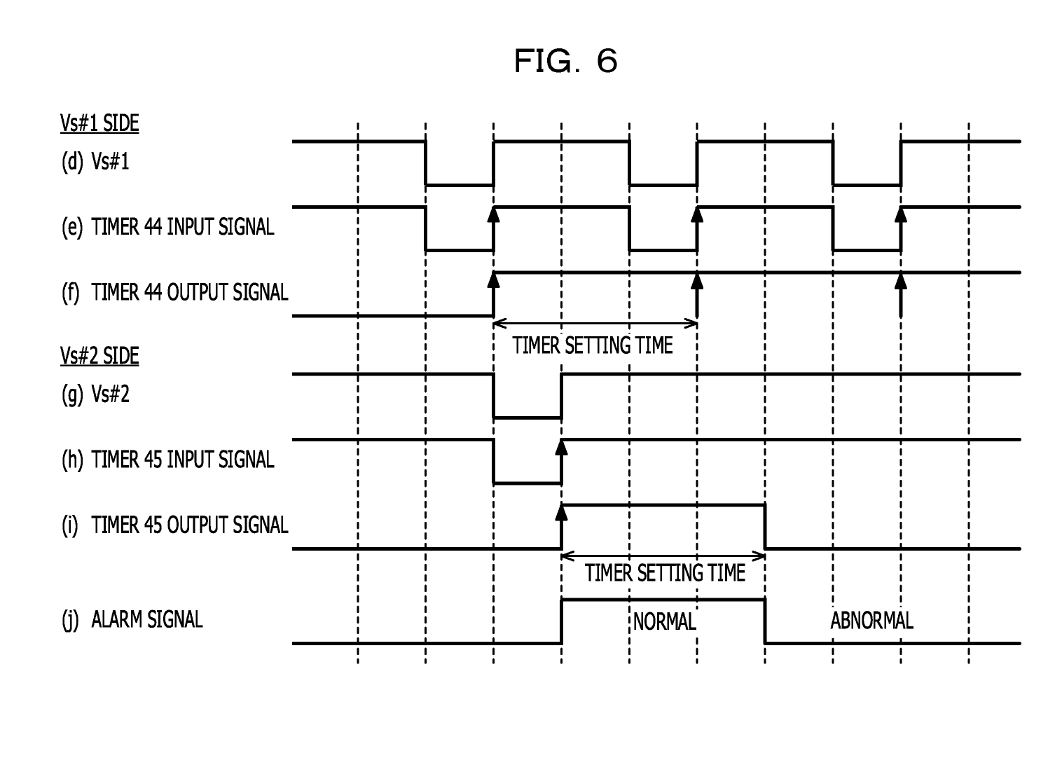

FIG. 6 illustrates an exemplary operation of a malfunction detection circuit. FIG. 6 may illustrate signal waveforms generated when the malfunction detection circuit 24 illustrated in FIG. 4 abnormally operates. In FIG. 6, the power-on signal POWER-ON (a), the power-good signal POWER-GOOD (b), and the clear signal (c) illustrated in FIG. 5 may be omitted. The types of the signals (d) to (j) illustrated in FIG. 6 may be substantially the same as those of signals (d) to (j) illustrated in FIG. 5.

In FIG. 6, for example, a malfunction occurs in the slave IC 21-2 illustrated in FIG. 1, and the voltage Vs#2 (g) does not have temporal voltage changes according to the switching operation. Therefore, the timer circuit 45 does not receive a subsequent rising edge in the input signal (h) before the predetermined time period, e.g., the timer setting time, elapses, and the output of the timer circuit 45 (i) is set back to the low level, causing the low level state to hold. The alarm signal (j) which is the output of the timer circuit 45 becomes the low level, and a notification of a malfunction is transmitted.

For example, the malfunction detection circuit 24 illustrated in FIG. 4 detects presence or absence of a malfunction based on presence or absence of a temporal voltage change according to the switching operation of the transistors of a slave IC. For example, presence or absence of a malfunction may be detected by detecting presence or absence of a voltage change at temporal intervals according to the period of the switching operation of the transistors of a slave IC. Therefore, since a short-circuit fault of a transistor may be detected in a time period that are substantially equal to one period of the switching operation, the power supply from the input power supply circuit 10 may be immediately interrupted.

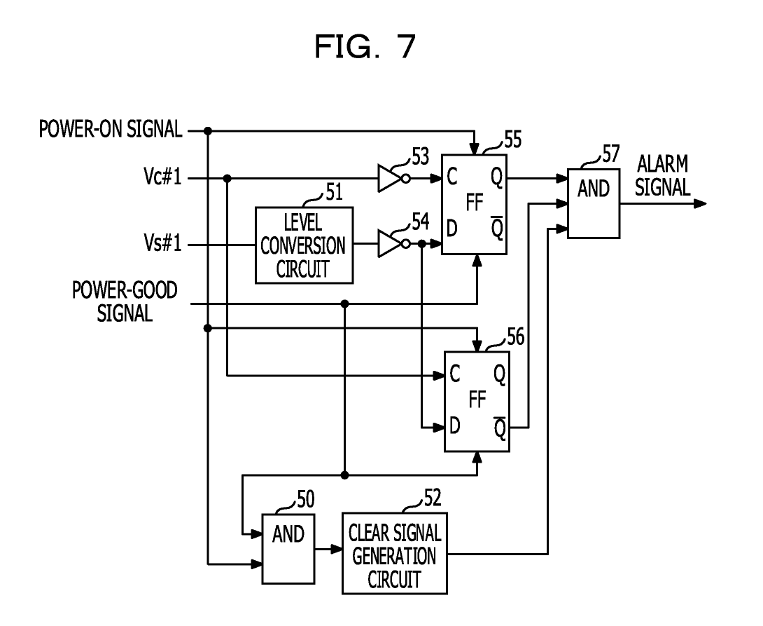

FIG. 7 illustrates an exemplary malfunction detection circuit. FIG. 7 may illustrate a section of the malfunction detection circuit 24, e.g., a section for detecting a malfunction in the slave IC 21-1. Other sections of the malfunction detection circuit 24 for the slave ICs 21-2 and 21-3 may have a configuration which is substantially the same as or similar to that illustrated in FIG. 7. The malfunction detection circuit 24 illustrated in FIG. 7 includes an AND circuit 50, a level conversion circuit 51, a clear signal generation circuit 52, inverters 53 and 54, flip-flops 55 and 56, and an AND circuit 57.

The malfunction detection circuit 24 illustrated in FIG. 7 detects presence or absence of a temporal voltage change, for example, by detecting the voltage Vs#1 at the second node N2 illustrated in FIG. 2 in accordance with a voltage change in the control signal Vc#1. For example, in the malfunction detection circuit 24, the flip-flop 56 detects a first value, e.g., the high level, of the voltage Vs#1 at the second node N2 in response to a change in the control signal Vc#1 from the first voltage, e.g., the low level, to the second voltage, e.g., the high level. In the malfunction detection circuit 24, the flip-flop 55 detects a second value, e.g., the low level, of the voltage Vs#1 at the second node N2 in response to a change in the control signal Vc#1 from the second voltage, e.g., the high level, to the first voltage, e.g., the low level. In the malfunction detection circuit 24, the AND circuit 57 detects presence or absence of a temporal change based on the first and second values. In a normal operation state, since the voltage Vs#1 temporally changes, the first and second values may be different from each other. In an abnormal operation state in which a short-circuit fault occurs in a transistor, since the voltage Vs#1 does not temporally change, the first and second values may be substantially the same.

For example, the flip-flop 56 stores the logical value corresponding to the voltage Vs#1 at the second node N2, in response to a change in the control signal Vc#1 from the first voltage, e.g., the low level, to the second voltage, e.g., the high level. The flip-flop 55 stores the logical value corresponding to the voltage Vs#1 at the second node N2, in response to a change in the control signal Vc#1 from the second voltage, for example, the high level, to the first voltage, for example, the low level. The AND circuit 57 performs a logical operation on the value stored in the flip-flop 55 and the value stored in the flip-flop 56. For example, the AND circuit 57 obtains logical multiplication of the Q output of the flip-flop 55, for example, the same logical value as the stored value, and the inverse Q output of the flip-flop 56, for example, the logical value which is the inverse of the stored value.

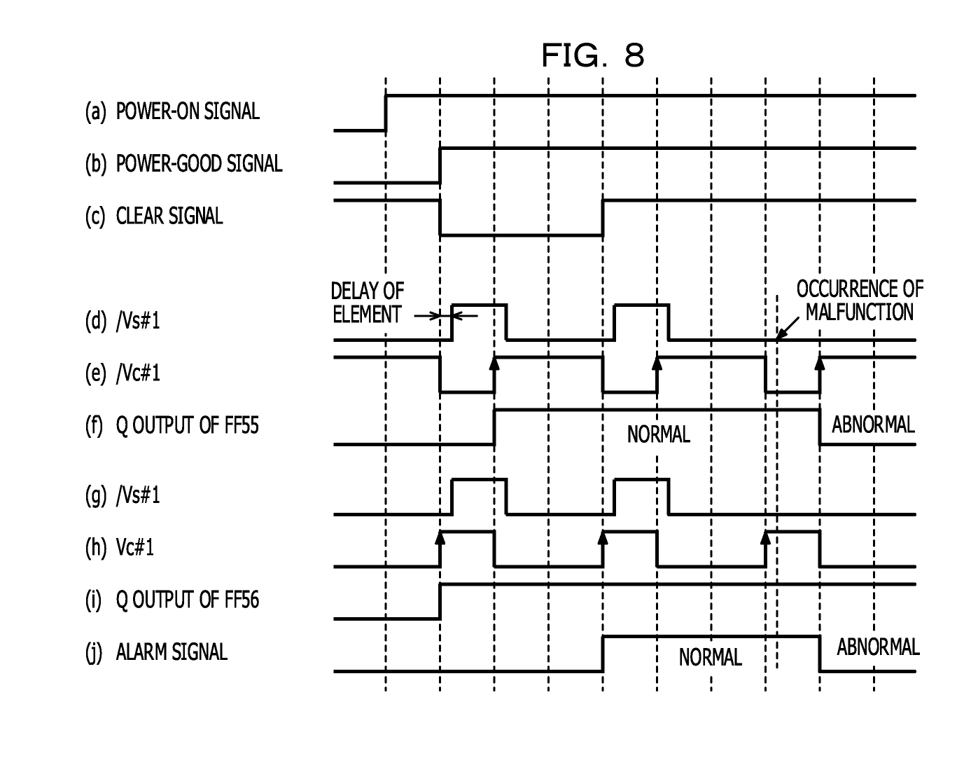

FIG. 8 illustrates an exemplary operation of a malfunction detection circuit. FIG. 8 may illustrate signal waveforms in the malfunction detection circuit 24 illustrated in FIG. 7.

The AND circuit 50 performs an AND operation on the power-on signal POWER-ON (a) and the power-good signal POWER-GOOD (b), and outputs the result of the AND operation. The output of the AND circuit 50 is supplied to the clear signal generation circuit 52. When the output of the AND circuit 50 becomes the high level, the clear signal generation circuit 52 which outputs a clear signal sets the clear signal to the low level for a predetermined time period. After the predetermined time period has elapsed, the clear signal generation circuit 52 sets the clear signal to the high level.

The level conversion circuit 51 receives the output voltage Vs#1 of the slave IC 21-1 illustrated in FIG. 1 as an input, and may generate a signal having an adequate voltage obtained through level conversion, for example, a waveform which is substantially the same as the voltage Vs#1, as an input to the inverter 54. The inverter 54 generates signals /Vs#1 (d) and (g) obtained by inverting the signal obtained through level conversion. The inverter 53 inverts the control signal Vc#1 to generate an inverted control signal /Vc#1 (e).

The flip-flop 55 takes in (latches) the signal /Vs#1 (d) which is applied to the data input (D input) in synchronization with a rising edge of the inverted control signal /Vc#1 (e) which is applied to the clock input (C input). The signal (f) indicates the Q output of the flip-flop 55, for example, a non-inverted output. The Q output of the flip-flop 55 is at the high level in a normal operation state, whereas it is at the low level in an abnormal operation state, for example, in which a short-circuit fault occurs in the HIGH-side transistor.

The flip-flop 56 takes in (latches) the signal /Vs#1 (g) which is applied to the data input (D input) in synchronization with a rising edge of the control signal Vc#1 (h) which is applied to the clock input (C input). The signal (i) indicates the /Q output (inverted output) of the flip-flop 56. The /Q output of the flip-flop 56 is at the high level in a normal operation state, whereas it is at the low level in an abnormal operation state, for example, in which a short-circuit fault occurs in the LOW-side transistor.

The AND circuit 57 performs an AND operation on the Q output of the flip-flop 55, the /Q output of the flip-flop 56, and the clear signal, and outputs the result of the AND operation. The signal (j) indicates the output of the AND circuit 57 corresponding to the alarm signal. The alarm signal (j) is set to the high level in a normal operation state, whereas it is set to the low level in an abnormal operation state. In FIG. 8, the levels of the signals /Vs#1 (d) and (g) are fixed to the low level from some midpoint based on an abnormal operation such as a short-circuit fault of the HIGH-side transistor. Therefore, the Q output of the flip-flop 55 (f) becomes the low level, and the output of the AND circuit 57 (j) corresponding to the alarm signal also becomes the low level, resulting in transmission of a notification of a malfunction.

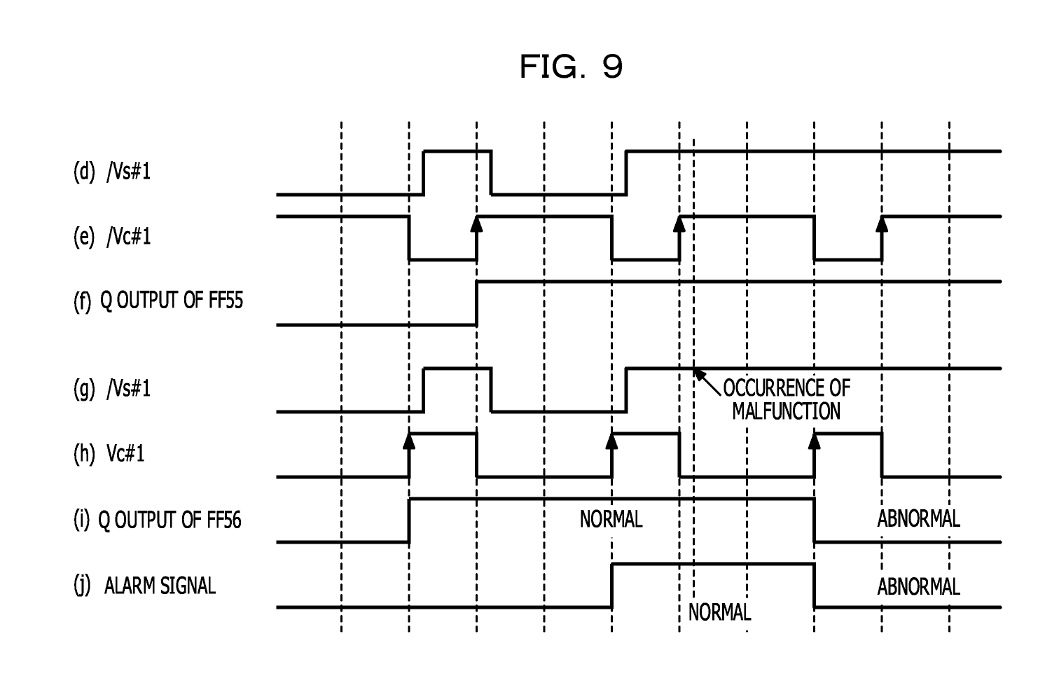

FIG. 9 illustrates an exemplary operation of a malfunction detection circuit. FIG. 9 may be a diagram illustrating signal waveforms in the malfunction detection circuit 24 illustrated in FIG. 7. In FIG. 9, the power-on signal POWER-ON, the power-good signal POWER-GOOD, and the clear signal which correspond to the signals (a) to (c) illustrated in FIG. 8 may be omitted. The signal types corresponding to the signals (d) to (j) illustrated in FIG. 9 may be substantially the same as the types of the signals (d) to (j) illustrated in FIG. 8.

In FIG. 9, the levels of the signals /Vs#1 (d) and (g) are fixed to the high level at some midpoint based on an abnormal operation such as a short-circuit fault of the LOW-side transistor. Therefore, the /Q output of the flip-flop 56 (i) becomes the low level, and the alarm signal (j) which is the output of the AND circuit 57 also becomes the low level, resulting in transmission of a notification of a malfunction.

The malfunction detection circuit 24 illustrated in FIG. 7 detects presence or absence of a malfunction based on presence or absence of a temporal voltage change according to the switching operation of the transistors in a slave IC. For example, presence or absence of a voltage change is detected at temporal intervals according to the period of the switching operation of the transistors in a slave IC, and presence or absence of a malfunction is detected. Therefore, since a short-circuit fault in a transistor is detected in a time period that is substantially equal to one period of the switching operation, the power supply from the input power supply circuit 10 may be immediately interrupted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A fault detection circuit comprising:
a switching element, disposed between a first node and a second node, configured to perform a switching operation in accordance with a control signal; and
a detection circuit configured to detect a temporal voltage change at the second node according to the switching operation of the switching element.

2. The fault detection circuit according to claim 1,
wherein the detection circuit detects a presence or an absence of the temporal voltage change by detecting the voltage at the second node in accordance with a voltage change in the control signal.

3. The fault detection circuit according to claim 1,
wherein the detection circuit detects a first value of the voltage at the second node in response to a first change in the control signal from a first voltage to a second voltage, detects a second value of the voltage at the second node in response to a second change in the control signal from the second voltage to the first voltage, and detects a presence or an absence of the temporal voltage change based on the first value and the second value.

4. The fault detection circuit according to claim 1, wherein the detection circuit includes:
a first flip-flop configured to store a logical value corresponding to the voltage at the second node in response to a first change in the control signal from a first voltage to a second voltage; and
a second flip-flop configured to store a logical value corresponding to the voltage at the second node in response to a second change in the control signal from the second voltage to the first voltage.

5. The fault detection circuit according to claim 4, further comprising:
a logic circuit configured to perform a logical operation on the value stored in the first flip-flop and the value stored in the second flip-flop.

6. An electronic equipment comprising:
a switching element, disposed between a first node and a second node, configured to perform a switching operation in accordance with a control signal;
a filter circuit configured to filter the voltage at the second node;
a load circuit configured to receive the output voltage of the filter circuit; and
a detection circuit configured to detect a temporal voltage change at the second node according to the switching operation of the switching element.

7. The electronic equipment according to claim 6, further comprising,
a power supply control circuit configured to stop a supply of a power supply voltage to the first node when the detection circuit detects an absence of the temporal voltage change.

8. The electronic equipment according to claim 6,
wherein the detection circuit detects a presence or an absence of the temporal voltage change by detecting the voltage at the second node in accordance with a voltage change in the control signal.

9. The electronic equipment according to claim 6,
wherein the detection circuit detects a first value of the voltage at the second node in response to a first change in the control signal from a first voltage to a second voltage, detects a second value of the voltage at the second node in response to a second change in the control signal from the second voltage to the first voltage, and detects a presence or an absence of the temporal voltage change based on the first value and the second value.

10. The electronic equipment according to claim 6,
wherein the detection circuit includes:
a first flip-flop configured to store a logical value corresponding to the voltage at the second node in response to a first change in the control signal from a first voltage to a second voltage; and
a second flip-flop configured to store a logical value corresponding to the voltage at the second node in response to a second change in the control signal from the second voltage to the first voltage.

11. The electronic equipment according to claim 10, further comprising,
a logic circuit configured to perform a logical operation on the value stored in the first flip-flop and the value stored in the second flip-flop.

12. A fault detection method comprising:
switching a conducting state or a non-conducting state of a switching element disposed between a first node and a second node based on a control signal that alternates between a first voltage and a second voltage; and
detecting a temporal voltage change at the second node according to a switching operation of the switching element.

13. The fault detection method according to claim 12, further comprising:
detecting a first value of the voltage at the second node in response to a first change in the control signal from the first voltage to the second voltage;
detecting a second value of the voltage at the second node in response to a second change in the control signal from the second voltage to the first voltage; and
detecting a presence or an absence of the temporal change based on the basis of the first value and the second value.
